(19) United States
(12) Patent Application Publication
(10) Pub. No.: US 2010/0128098 A1
(43) Pub. Date: May 27, 2010

(54) INKJET PRINTER

(75) Inventors: Hiroshi HASHI, Tokyo (JP); Hidehiko IDA, Tokyo (JP)

Correspondence Address: FRISHAUF, HOLTZ, GOODMAN & CHICK, P.C., 220 Fifth Avenue - 16th Floor, New York, NY, 10017-2023, US

(73) Assignee: Olympus Corporation, Tokyo (JP)

(21) Appl. No.: 12/623,604

(22) Filed: Nov. 23, 2009

(30) Foreign Application Priority Data
Nov. 27, 2008 (JP) 2008-303017

(51) Int. Cl. B41J 2/01

(52) U.S. Cl. 347/108

(57) ABSTRACT

The inkjet printer of the present invention includes: a transportation unit for transporting a recording medium; a recording unit including a recording head that jets ink to the recording medium transported by the transportation unit; an ink path for supplying ink to the recording head; a first housing accommodating the transportation unit and the recording unit; and a second housing attached to the first housing and accommodating a portion of the ink path, wherein the second housing is attached to the first housing in such a way that it can be moved to a first position and to a second position that is different from the first position.

### CROSS REFERENCE TO RELATED APPLICATION

This application is based upon and claims the benefit of priority from prior Japanese Application No. 2008-303017, filed Nov. 27, 2008, the entire contents of which are incorporated herein by reference.

### BACKGROUND OF THE INVENTION

1. Field of the Invention

The present invention relates to an inkjet printer that is capable of easily performing maintenance on an ink path.

2. Description of the Related Art

Conventionally, an inkjet printer that records an image on a recording medium by jetting ink from a recording head is known. As systems for supplying ink to the recording head in such the inkjet printer, there are two types of systems, i.e., a circulation system and a non-circulation system.

For example, Japanese Patent Application Publication No. 2001-219580 discloses an ink path using the circulation system. In order to supply ink to a recording head, the ink path in Japanese Patent Application Publication No. 2001-219580 comprises a first ink container provided higher than the recording head, a second ink container provided lower than the recording head, and a pump.

Ink is supplied to the recording head by means of the difference in elevation between the first and second ink containers. The ink collected in the second ink container is sent to the first ink container using the pump. In this way, the ink path in Japanese Patent Application Publication No. 2001-219580 circulates ink.

As another example, Japanese Patent Application Publication No. 2008-162175 discloses an ink path using the non-circulation system. The ink path in Japanese Patent Application Publication No. 2008-162175 comprises a sub tank for temporarily pooling ink supplied from an ink bag as a cartridge. The ink in the sub-tank is supplied to the recording head.

The ink paths in Japanese Patent Application Publication No. 2001-219580 and Japanese Patent Application Publication No. 2008-162175 described above are accommodated in the same housing as the one which accommodates a recording unit including the recording head and accommodates a transportation unit for transporting the recording medium.

### SUMMARY OF THE INVENTION

The inkjet printer according to the present invention comprises a transportation unit for transporting a recording medium, a recording unit including a recording head that jets ink to the recording medium transported by the transportation unit, an ink path for supplying ink to the recording head, a first housing accommodating the transportation unit and the recording unit, and a second housing attached to the first housing and accommodating a portion of the ink path. The second housing is attached to the first housing in such a way that it can be moved to a first position and to a second position that is different from the first position.

### BRIEF DESCRIPTION OF DRAWINGS

FIG. 1 are diagrams showing a schematic of an inkjet printer of a first embodiment of the present invention, with illustration of an ink path being omitted; FIG. 1A shows the configuration when an image is recorded and FIG. 1B shows the configuration when an image is not recorded.

FIG. 2 is a diagram showing a first and a second housing that configure a body frame of the inkjet printer of the first embodiment.

FIG. 3 is a diagram showing the configuration of a transportation unit of the inkjet printer of the first embodiment.

FIG. 4 is a perspective view in which the configuration of a recording unit of the inkjet printer of the first embodiment is viewed from the under side.

FIG. 5 is a diagram showing an ink path of the inkjet printer of the first embodiment and showing the relationship between the first and a second housing and the ink path.

FIG. 6 is a diagram in which the relationship between the first housing, the second housing, and the ink path of the inkjet printer of the first embodiment is viewed from the top side.

FIGS. 7A and 7B are diagrams showing exemplary modification 1 of the form for attaching the second housing to the first housing of the inkjet printer of the first embodiment.

FIG. 8A is a diagram showing exemplary modification 2 of the form for attaching the second housing to the first housing of the inkjet printer of the first embodiment.

FIG. 8B is a perspective view showing only the second housing of exemplary modification 2 of the first embodiment.

FIG. 9 is a diagram showing an ink path of an inkjet printer of a second embodiment of the present invention and showing the relationship between a first and a second housing and the ink path.

FIG. 10 is a diagram showing an ink path of an inkjet printer of a third embodiment and showing the relationship between a first and a second housing and the ink path.

### DESCRIPTION OF THE PREFERRED EMBODIMENTS

### First Embodiment

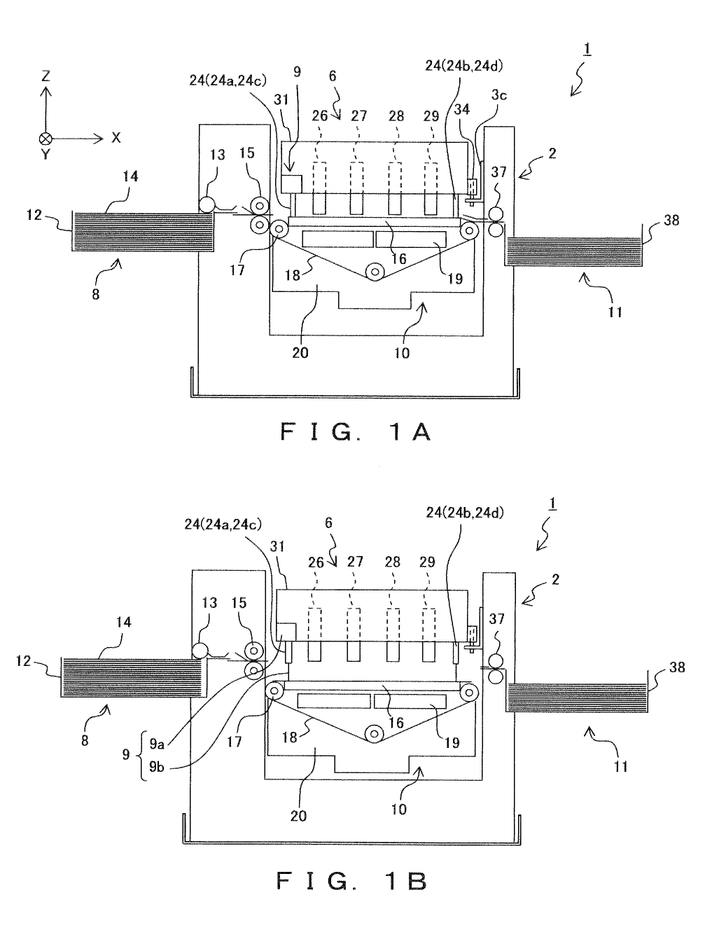

FIG. 1 are diagrams showing a schematic of an inkjet printer of a first embodiment of the present invention, with illustration of an ink path being omitted.; FIG. 1A shows the configuration when an image is recorded and FIG. 1B shows the configuration when an image is not recorded.

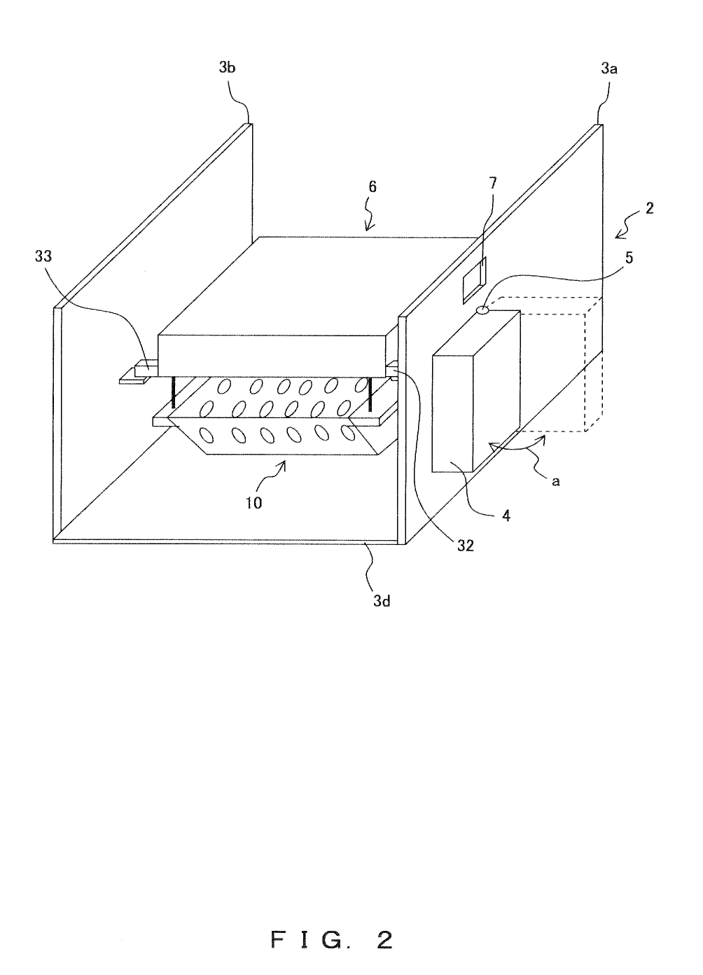

FIG. 2 is a diagram showing a first and a second housing that configure a body frame of the inkjet printer of the first embodiment.

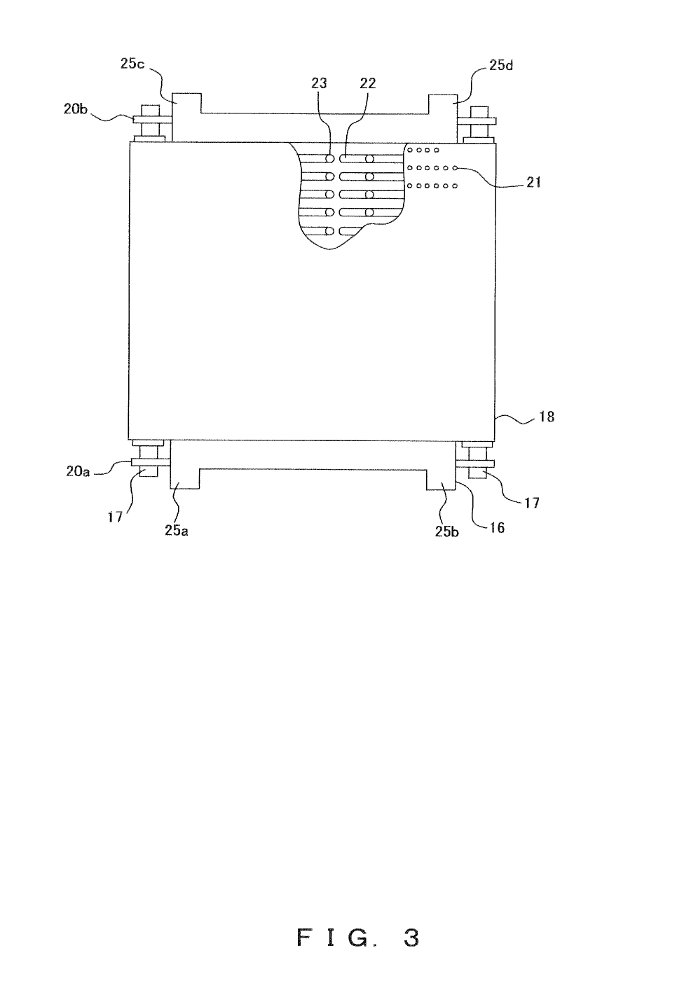

FIG. 3 is a diagram showing the configuration of a transportation unit of the inkjet printer of the first embodiment.

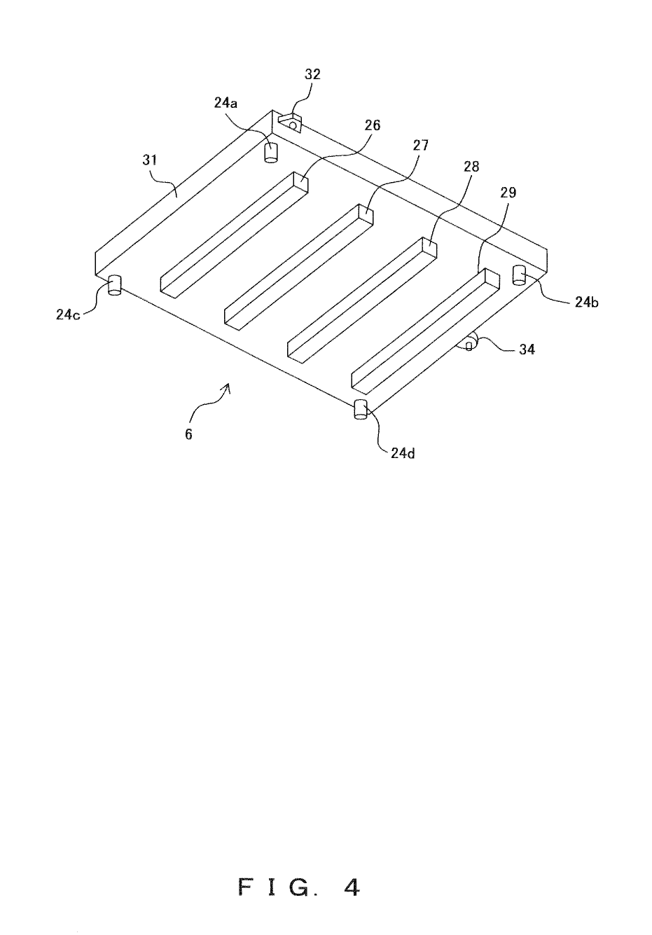

FIG. 4 is a perspective view in which the configuration of a recording unit of the inkjet printer of the first embodiment is viewed from the under side.

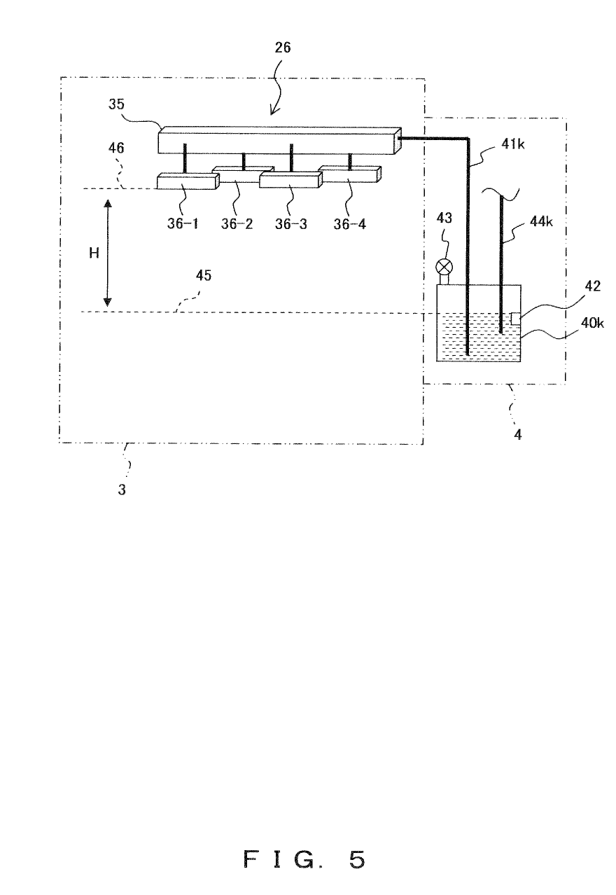

FIG. 5 is a diagram showing an ink path of the inkjet printer of the first embodiment and showing the relationship between the first and a second housing and the ink path.

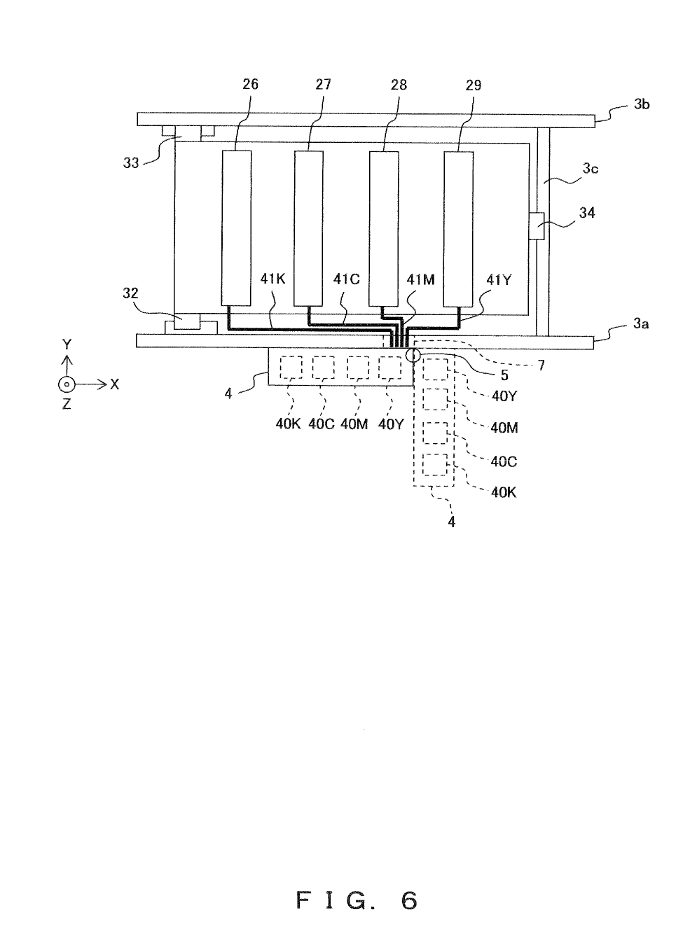

FIG. 6 is a diagram in which the relationship between the first housing, the second housing, and the ink path of the inkjet printer of the first embodiment is viewed from the top side.

In the following description, a transportation direction of a recording medium is referred to as an X-axis direction and a direction orthogonal to the transportation direction is referred to as a Y-axis direction or the width direction of the recording medium. A direction orthogonal to the X-axis direction and the Y-axis direction is referred to as a Z-axis direction or a vertical direction.

As shown in FIGS. 1A and 1B, an inkjet printer 1 includes a body frame 2. As shown in FIG. 2, the body frame 2 comprises a first housing 3 (3a, 3b, 3c and 3d) and a second housing 4.

The first housing 3 comprises at least side face frames 3a and 3b, a tie bar 3c (see FIG. 6), and a bottom face 3d.

The second housing 4 is configured in such a way that, as indicated by arrow a, it can rotate about a rotation axis 5 relative to the first housing 3 so as to be positioned at a first position indicated by a solid line and at a second position indicated by a dashed line. In the present embodiment, the second housing 4 is attached to the side face frame 3a of the first housing 3. An opening 7 through which a tube from a recording unit 6 can pass is formed on the side face frame 3a (a detailed descriptions of this will be given later).

A medium supplying unit 8, a movement unit 9, a transportation unit 10, a recording unit 6, and a medium ejection unit 11 are placed in the first housing 3.

The medium supplying unit 8 includes a feed tray 12 and a pickup roller 13. The feed tray 12 and the pickup roller 13 are supported by the side face frames 3a and 3b.

A plurality of recording medium 14 composed of, for example, paper or the like are placed in the feed tray 12. The recording medium 14 placed on the feed tray 12 are supplied one by one to the transportation unit 10 by the pickup roller 13, supplying from the one placed on the top.

The transportation unit 10 is accommodated in the first housing 3. As shown in FIGS. 1 and 3, the transportation unit 10 includes a resist roller pair 15, a platen 16, a plurality of rollers 17, a transportation belt 18, a fan 19, and a transportation frame 20 (20a and 20b).

The resist roller pair 15 clears (i.e., corrects) inclinations of the recording medium 14 sent by the pickup roller 13. The resist roller pair 15 then transports the recording medium 14 to the transportation belt 18 at a proper timing for image recording.

The resist roller pair 15 is supported by the side face frames 3a and 3b.

As shown in FIG. 3, the transportation frames 20a and 20b are placed at both ends of the side that is orthogonal direction to the running direction of the transportation belt 18. In other words, the transportation frames 20a and 20b are placed at the upper part and the lower part in FIG. 3.

The transportation frames 20a and 20b support the plurality of rollers 17 in such a way that these rollers can rotate.

The transportation belt 18 is formed of endless belt having a large number of suction holes 21. The transportation belt 18 held under tension by the plurality of rollers 17.

The transportation frames 20a and 20b also support the platen 16, which was processed to have a predetermined flatness, and the fan 19 placed below the platen 16, such that the recording medium 14 does not meander.

On the platen 16, a plurality of grooves 22, which extend in the recording medium transportation direction, are formed in the region facing the transportation belt 18. A suction hole 23 in communication with the fan 19 is formed on the grooves 22.

In this way, the suction hole 23 of the platen 16 and the suction hole 21 of the transportation belt 18 serve to adsorb the recording medium 14 on the transportation belt 18 by means of the suction force of the fan 19.

The transportation belt 18 moves via a drive motor attached to at least one of the plurality of rollers 17 being driven. The transportation belt 18 then adsorbs and holds the recording medium 14 sent by the resist roller pair 15 he transportation belt 18 transport the recording medium 14 downstream of the transportation direction at a predetermined rate.

Abutting units 25 (25a, 25b, 25c and 25d) on which gap adjustment members 24 (24a, 24b, 24c and 24d) abut for adjusting the space between the recoding unit 6 and the transportation unit 10 are formed on the platen 16.

The movement unit 9 comprises a driving source 9a and a wire 9b. One end of the wire 9b is fixed on a shaft (not shown) extending from the driving source 9a. The other end of the wire 9b is fixed on the platen 16 via the gap adjustment members 24. In the present embodiment, four wires are used as the wires 9b and the other ends above of the four wires 9b are respectively fixed on the abutting units 25 (25a, 25b, 25c and 25c), which are the four corners of the platen 16.

By driving the driving source 9a, the movement unit 9 rotates the shaft (not shown) to reel or unreel the wires 9b. In this way, the transportation unit 10 moves to an image recording position shown in FIG. 1A and to an evacuation position (i.e., non image-recording position) shown in FIG. 1B.

In the present embodiment, the transportation unit 10 is moved by the wires 9b. However, the configuration is not limited to this. The movement unit 9 can have any configuration as long as the transportation unit 10 can move to the image recording position and the evacuation position.

The recording unit 6 is accommodated in the first housing 3. The recording unit 6 is placed facing the transportation unit 10. As shown in FIGS. 1 and 4, the recording unit 6 includes head units 26, 27, 28 and 29, a head holder 31, supporting units 32, 33 and 34, and the gap adjustment members 24 (24a to 24d) described above.

The head units 26, 27, 28 and 29 respectively jet black (K) ink, cyan (C) ink, magenta (M) ink, and yellow (Y) ink to the recording medium 14 transported by the transportation unit 10.

The head units 26, 27, 28 and 29 extend in the direction orthogonal to the transportation direction of the recording medium 14 and have a width that is as great as or greater than a recording region on the recording medium 14. In this way, the head units 26, 27, 28 and 29 configure a line head.

As an example, as shown in FIG. 5, the head unit 26 in the present embodiment comprises an ink distributor 35 and four recording heads 36-1 to 36-4. The ink distributor 35 is provided to temporarily pool ink to be distributed to each of the recording heads 36-1 to 36-4.

The head units 26, 27, 28 and 29 are fixed and held by the head holder 31. The head units 27, 28 and 29 also have configurations similar to that of the head unit 26.

Two supporting units 32 and 33 are provided on the feeding-side face of the head holder 31 and the supporting unit 34 is provided on the ejecting-side face of the head holder 31.

The head holder 31 is supported on the first housing 3 by three supporting units 32, 33 and 34. In detail, the supporting units 32 and 33 are supported by the side face frames 3a and 3b as shown in FIG. 2. The supporting unit 34 is, as shown in FIG. 1, supported by the tie bar 3c that serves as a bridge between the side face frames 3a and 3b.

The gap adjustment members 24 (24a to 24d) are provided on a face of the head holder 31, which is opposed to the transportation unit 10. The gap adjustment mechanisms 24 (24a to 24d) are provided at positions that are opposed to the abutting units 25a, 25b, 25c and 25d formed on the platen 16.

When the transportation unit 10 is lifted upward using the wires 9b described above, the gap adjustment members 24a, 24b, 24c and 24d abut on the abutting units 25a, 25b, 25c and 25d formed on the platen 16.

This determines the positions of the head holder 31 and the platen 16 in the height direction (Z direction). In other words, the space between the head units 26, 27, 28 and 29 and the transportation belt 18 is defined in accordance with a predetermined gap amount.

The medium ejection unit 11 includes an ejection roller pair 37 and an ejection tray 38. The ejection tray 38 and the ejection roller pair 37 are supported by the side face frames 3a and 3b. The recording medium 14 on which an image is recorded by the recording unit 6 is ejected into the ejection tray 38 by the ejection roller pair 37.

In the image recording operations performed by the inkjet printer 1 that is configured as described above, under the state shown in FIG. 1A, the recording medium 14 stored in the feed tray 12 are taken out one by one by the pickup roller 13 and are sent to the resist roller pair 15.

The resist roller pair 15 corrects the inclination of the recording medium 14 and transports it to the transportation belt 18 at the proper timing for image recording.

The recording medium 14 transported to the transportation belt 18 is adsorbed and held on the transportation belt 18 by the fan 19, such that it is transported in accordance with the movement of the transportation belt 18.

In this way, the recording medium 14 sequentially arrive at positions below the head units 26, 27, 28 and 29. Then, the head units 26, 27, 28 and 29 jet ink and record information, such as characters or images, on the recording medium 14. The recording medium 14 on which images are recorded is ejected into the ejection tray 38 by the ejection roller pair 37.

Next, an ink path of the present embodiment will be described using FIGS. 5 and 6.

FIG. 5 shows the ink path for K-color ink only. The ink paths for the other colors are similar to the one for K-color.

As shown in FIG. 5, the ink path for supplying ink to the head unit 26 comprises a sub tank 40K accommodated in the second housing 4, and a tube 41K that connects the sub tank 41K to the head unit 26 accommodated in the first housing 3.

A liquid surface detector 42 and an air releasing valve 43 are provided at the sub tank 40K. The liquid surface detector 42 monitors the amount of the ink in the sub tank 40K such that the amount is a predetermined amount. Specifically, the liquid surface detector 42 performs monitoring such that the amount of the ink in the sub tank 40K is an ink liquid surface 45.

When the liquid surface detector 42 senses that the amount of the ink in the sub tank 40K is equal to or smaller than a predetermined amount, ink is supplied from an ink cartridge (not shown) through a tube 44K. The ink cartridge may be accommodated in either of the first housing 3 and the second housing 4.

The air releasing valve 43 is provided to let air in and out of the sub tank 40K. The sub tank 40K configured as described above is placed in the second housing 4 in such a way that it is positioned lower than the head unit 26 in the direction of a gravitational force.

In more detail, the sub tank 40K is placed in the second housing 4 in such a way that the ink liquid surface 45 of the sub tank 40K is lower than a nozzle face 46 of the recording heads 36-1 to 36-4, by height H in the direction of the gravitational force.

In this way, when the air releasing valve 43 is opened, a predetermined negative pressure is applied to each of the recording heads 36-1 to 36-4 and proper meniscuses are formed. In other words, when an image is recorded, the air releasing valve 43 is opened to record the image. A purging process for each of the recording heads 36-1 to 36-4 can be performed by closing the air releasing valve 43 to apply pressure into the sub tank 40K.

One end of the tube 41K is soaked in ink in the sub tank 40K. The other end of the tube 41K is connected to the ink distributor 35 of the head unit 26 accommodated in the first housing 3.

In the present embodiment, the tube 41K is connected to the ink distributor 35. However, it may also be directly connected to each of the recording heads 36-1 to 36-4 without the ink distributor 35 being provided.

As shown in FIG. 6, the sub tanks 40K, 40C, 40M and 40Y corresponding to the head units 26 to 29 are accommodated in the second housing 4.

The head units 26 to 29 and the sub tanks 40K to 40M are connected via the respective tubes 41K, 41C, 41M and 41Y that pass through the opening 7 formed on the side face frame 3a.

When recording is performed, the second housing 4 is located at the first position indicated by a solid line. When maintenance or inspection of the ink path is performed, the second housing 4 can be rotated (opened and closed) about the rotation axis 5 from the first position to the second position indicated by dashed lines.

The second position is upright relative to the side face frame 3a.

In this way, the second housing 4 is attached to the first housing 3 in such a way that it can be moved to the first position and to the second position that is different from the first position. Accordingly, the handling of the sub tanks 40K, 40C, 40M and 40Y accommodated in the second housing 4 is simplified. In other words, the maintenance or the inspection of the ink path can be easily performed.

When the maintenance or the inspection is terminated, the second housing 4 positioned at the second position is returned to the first position again.

As described above, in the present embodiment, in addition to the first housing 3 accommodating at least the transportation unit 13 and the recording unit 6, the second housing 4 is provided for accommodating the sub tanks 40K to 40Y that configure a portion of the ink path.

Relative to the first housing 3, the second housing 4 is rotated (opened and closed) from the first position to the second position, and the maintenance or the inspection of the ink path is performed when the second housing 4 is at the second position. In this way, the operations are riot needed to be performed in the first housing 3 whose inside is jammed (i.e., the space is narrow) because the transportation unit 13 and the recording unit 6 are accommodated.

### Exemplary Modification 1 of the First Embodiment

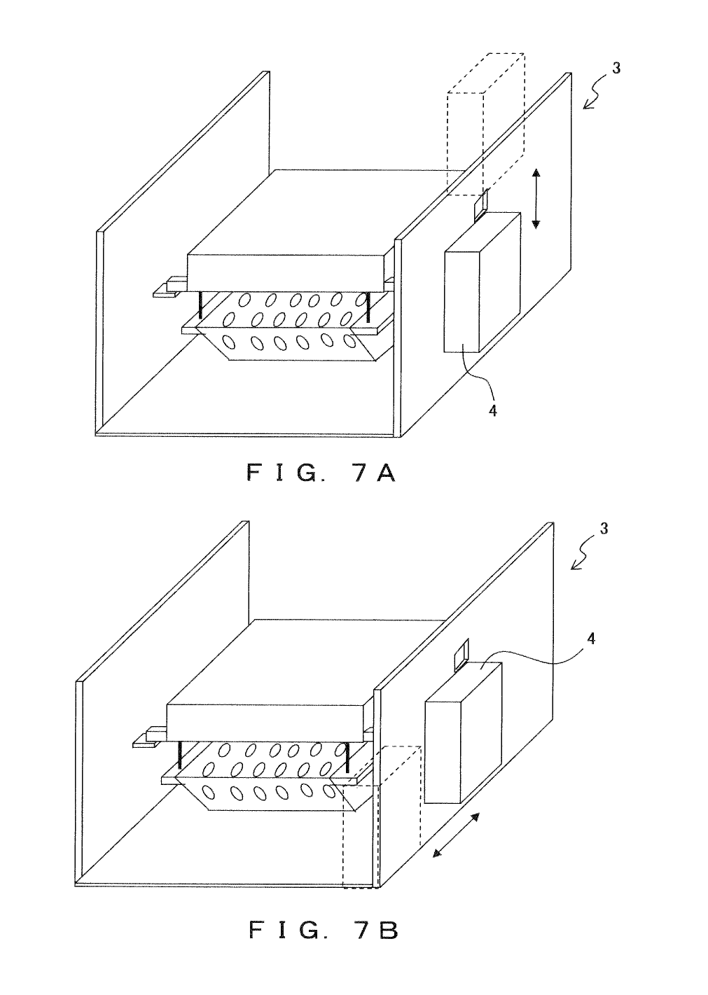

FIGS. 7A and 7B are diagrams showing exemplary modification 1 of the first embodiment. In the first embodiment, the second housing 4 is rotated (opened and closed) relative to the first housing 3. Exemplary modification 1 is different in the sense that the second housing 4 is attached in such a way that it can slide relative to the first housing 3.

Specifically, the second housing 4 slides in the vertical direction (see FIG. 7A) or in the transportation direction (see FIG. 7B) so as to shuttle between the first position indicated by a solid line and the second position indicated by a dashed line.

At the second position, at least a portion of the second housing 4 is not in contact with the first housing 3 such that the sub tanks in the second housing 4 can be easily accessed. Other than this, the configuration of exemplary modification 1 is similar to those in the first embodiment described above.

### Exemplary Modification 2 of the First Embodiment

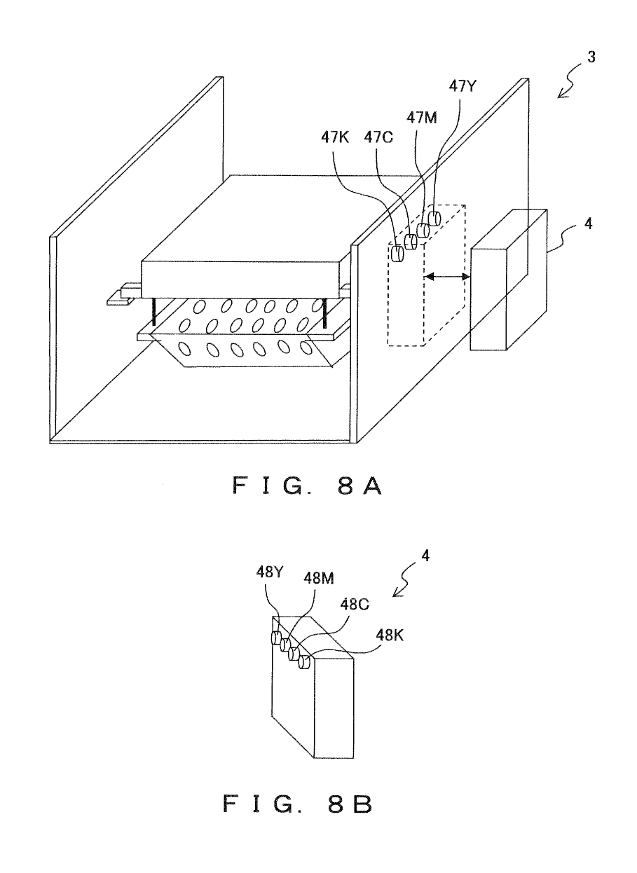

FIG. 8A is a diagram showing exemplary modification 2 of the first embodiment. FIG. 8B is a perspective view showing only the second housing 4 of exemplary modification 2 of the first embodiment.

In the first embodiment, the second housing 4 is rotated (opened and closed) relative to the first housing 3. Exemplary modification 2 is different in the sense that the second housing 4 is attached to the first housing 3 in such a way that it can be detached from the first housing 3. In FIG. 8A, the first and second positions of the second housing 4 are indicated by dashed lines and solid lines, respectively.

The tubes connected to the head units 26 to 29 are connected to first joints 47K to 47Y shown in FIG. 8A. The tubes connected to the sub tanks 40K to 40Y are connected to second joints 48K to 48Y shown in FIG. 8B.

When the second housing 4 is positioned at the first position, the second joints 48K to 48Y are connected to the first joints 47K to 47Y.

Each of the first joints 47K to 47Y and each of the second joints 48K to 48Y is configured such that ink does not leak when the second housing 4 is removed from the first housing 3. Other than this, the configuration of exemplary modification 2 is similar to those in the first embodiment described above.

### Second Embodiment

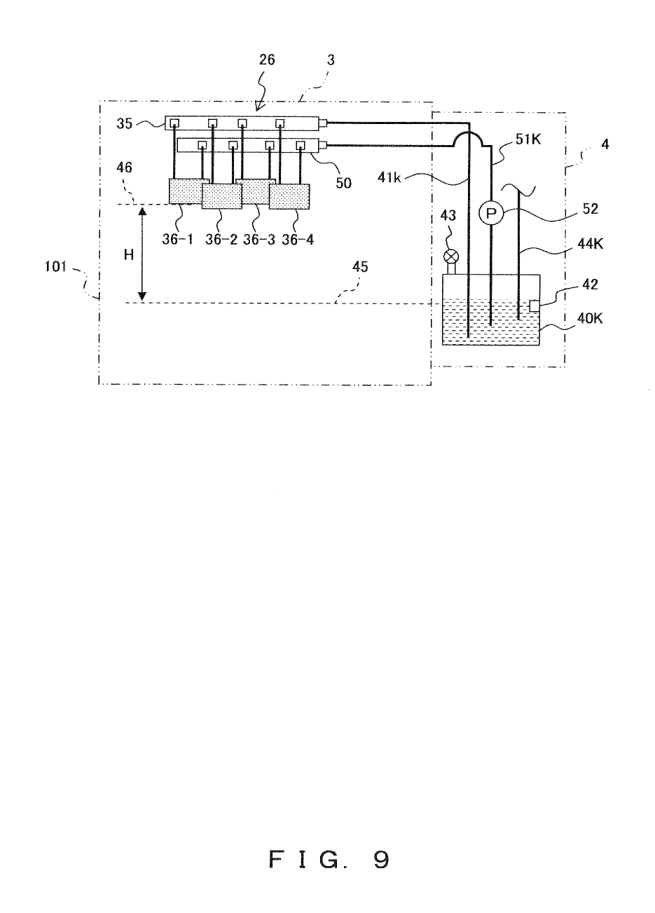

FIG. 9 is a diagram showing an ink path configuration of an inkjet printer of the second embodiment. In the present embodiment, in comparison with the ink path of the first embodiment using a non-circulatory system, an ink path is configured to use a circulatory system in order to eliminate bubbles in the ink path.

A head unit 26 of the present embodiment is provided with an ink collector 50 for temporarily collecting ink that was not jetted from recording heads 36-1 to 36-4. FIG. 9 shows the ink path for K-color ink only. The configurations of those for the other colors are similar to that of the ink path for K-color ink.

In the ink path of the present embodiment, a sub tank 40K placed lower than the recording heads 36-1 to 36-4 in the direction of the gravitational force, a tube 41K connecting the sub tank 40K to an ink distributor 35, a tube 51K connecting the sub tank 40K to the ink collector 50, and a pump 52 placed on the tube 51K configure an ink circulation unit.

In the present embodiment, the sub tank 40K and the pump 52 are placed in a second housing 4.

As is the case with the first embodiment described above, a liquid surface detector 42 and an air releasing valve 43 are provided in the sub tank 40K.

One end of the tube 41K is soaked in ink in the sub tank 40K. The other end of the tube 41K is connected to the ink distributor 35 of the head unit 26 accommodated in a first housing 3. In the present embodiment, the tube 41K is connected to the ink distributor 35. However, it may also be directly connected to each of the recording heads 36-1 to 36-4 without the ink distributor 35 being provided.

One end of the tube 51K is soaked in ink in the sub tank 40K. The other end of the tube 51K is connected to the ink collector 50 of the head unit 26 accommodated in the first housing 3.

In the present embodiment, the tube 51K is connected to the ink collector 50. However, it may also be directly connected to each of the recording heads 36-1 to 36-4 without the ink collector 50 being provided.

When an attempt is made to remove bubbles from the ink path, the pump 52 is driven and sends the ink in the sub tank 40K to the ink collector 50.

In the ink circulation unit, the sub tank 40K is placed such that an ink liquid surface 45 is lower than a nozzle face 46 of the recording heads 36-1 to 36-4 by height H.

When an image is recorded, the air releasing valve 43 is opened so as to put the sub tank 40K in an air release state and the pump 52 is disabled. In this way, a predetermined negative pressure is applied to the recording heads 36-1 to 36-4 so as to form meniscuses, as is the case with the first embodiment.

When an attempt is made to remove bubbles from the ink path, the pump 52 is driven while the sub tank 40K is maintained in the air release state. When the pump 52 is driven, ink is circulated in the order of the sub tank 40K→the pump 52→the ink collector 50→each of the recording heads→the ink distributor 35→the sub tank 40K. This enables bubbles to be removed from the ink path.

When the amount of the ink in the sub tank 40K is equal to or smaller than a predetermined amount, ink is supplied to the sub tank 40K from a cartridge (not shown) through a tube 44K.

The attachment relationship between the first housing 3 and the second housing 4 of the present embodiment is similar to those in FIGS. 2, 7A and 7B or FIGS. 8A and 8B indicated for the first embodiment and the exemplary modification of the first embodiment described above.

In the present embodiment, the sub tank 40K and the pump 52 are placed in the second housing 4. However, it is also possible for one of the sub tank 40K and the pump 52 to be placed in the second housing 4 and for the other to be placed in the first housing 3.

### Third Embodiment

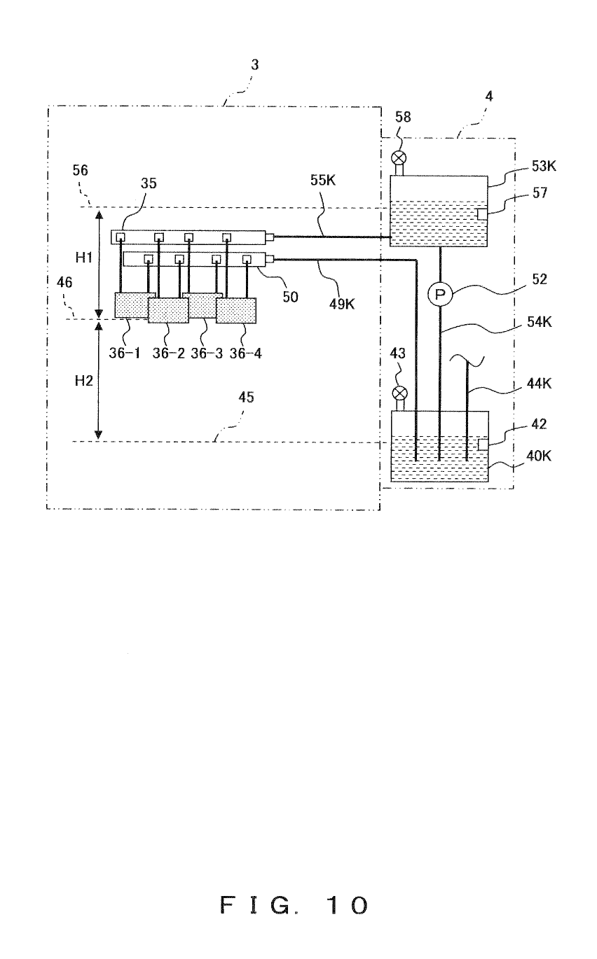

FIG. 10 is a diagram showing an ink path configuration of an inkjet printer of the third embodiment. In the present embodiment, in comparison with the ink path of the first embodiment using a non-circulatory system, an ink path is configured to use a circulatory system.

In the present embodiment, an image can be recorded while circulating ink. A head unit 26 of the present embodiment is provided with an ink collector 50 for temporarily collecting ink that was not jetted from recording heads 36-1 to 36-4. FIG. 10 shows the ink path for K-color ink only. The configurations of those for the other colors are similar to that of the ink path for K-color ink.

In the ink path of the present embodiment, a sub tank 40K placed lower than the recording heads 36-1 to 36-4 in the direction of the gravitational force, an upper sub tank 53K placed higher than that of the recording heads 36-1 to 36-4 in the direction of the gravitational force, a tube 49K connecting the ink collector 50 to the sub tank 40K, a tube 54K connecting the upper sub tank 53K to the sub tank 40K, a pump 52 placed on the tube 54K, and a tube 55K connecting the upper sub tank 53K to an ink distributor 35 configure an ink circulation unit.

In the present embodiment, the sub tank 40K, the upper sub tank 53K, and the pump 52 are placed in a second housing 4.

As is the case with the first embodiment described above, a liquid surface detector 42 and an air releasing valve 43 are provided in the sub tank 40K.

The upper sub tank 53K is placed in a second housing 4. A liquid surface detector 57 and an air releasing valve 58 are provided in the upper sub tank 53K. The liquid surface detector 57 monitors the amount of ink in the upper sub tank 53K such that this amount is a predetermined amount. Specifically, the liquid surface detector 57 performs monitoring such that the amount of ink in the upper sub tank 53K is an ink liquid surface 56. The air releasing valve 58 is provided to let air in and out of the upper sub tank 53K.

One end of the tube 49K is soaked in ink in the sub tank 40K. The other end of the tube 49K is connected to the ink collector 50 of the head unit 26 accommodated in a first housing 3. In the present embodiment, the tube 49K is connected to the ink collector 50. However, it may also be directly connected to each of the recording heads 36-1 to 36-4 without the ink collector 50 being provided.

One end of the tube 54K is soaked in ink in the sub tank 40K. The other end of the tube 54K is soaked in ink in the upper sub tank 53K.

One end of the tube 55K is soaked in ink in the upper sub tank 53K. The other end of the tube 55K is connected to the ink distributor 35 of the head unit 26 accommodated in the first housing 3.

In the present embodiment, the tube 55K is connected to the ink distributor 35. However, it may also be directly connected to each of the recording heads 36-1 to 36-4 without the ink distributor 35 being provided.

When the ink in the upper sub tank 53K is reduced, the pump 52 is driven and supplies ink from the sub tank 40K to the upper sub tank 53K.

In this ink circulation unit, the upper sub tank 53K is placed such that the height of the ink liquid surface 56 is greater than the height of a nozzle face 46 of the recording heads 36-1 to 36-4, by height H1.

The sub tank 40K is placed such that the height of the ink liquid surface 45 is less than the height of the nozzle face 46 of the recording heads 36-1 to 36-4, by height H2.

Heights H1 and H2 above are set such that a predetermined negative pressure is applied to the recording heads 36-1 to 36-4. In this way, moderate meniscuses are formed on the recording heads 36-1 to 36-4.

When ink is circulated while an image is being recorded, the air releasing valve 58 and an air releasing valve 43 are opened. Since the air releasing valve 58 is opened, the internal pressure of the upper sub tank 53K is equal to an ambient pressure. The internal pressure of the sub tank 40K is also equal to an ambient pressure since the air releasing valve 43 is opened.

Therefore, because of the difference in elevation between the upper sub tank 53K and the sub tank 40K, ink runs down by means of its own weight. Then, when the amount of the ink in the upper sub tank 53K is equal to or smaller than a predetermined amount, the pump 52 is driven and ink from the sub tank 40K is supplied to the upper sub tank 53K. In other words, during ink circulation, ink is circulated in the order of the sub tank 40K→the pump 52→the sub tank 53K→the ink distributor 35, each of the recording heads→the ink collector 50→the sub tank 40K.

When the amount of the ink in the sub tank 40K is equal to or smaller than a predetermined amount, ink is supplied from a cartridge (not shown) through the tube 44K to the sub tank 40K.

As described above, heights H1 and H2 are set such that a predetermined negative pressure is applied to the recording heads 36-1 to 36-4. Therefore, even while ink is circulated, meniscuses are formed on the recording heads 36-1 to 36-4 and a recording operation (i.e., ink jetting operation) can be performed.

During a non-recording period (i.e., non ink-circulation period) in which an image is not recorded, the air releasing valve 58 is closed. Here, ink does not drip off since a predetermined negative pressure is applied to the recording heads because of the difference in elevation (i.e., height H2) between the ink liquid surface 45 in the sub tank 40K and the nozzle face 46 of the recording heads 36-1 to 36-4.

The attachment relationship between the first housing 3 and the second housing 4 of the present embodiment is similar to those in FIGS. 2, 7A and 7B or FIGS. 8A and 8B indicated for the first embodiment and the exemplary modification of the first embodiment described above.

In the present embodiment, the sub tank 40K, the upper sub tank 53K, and the pump 52 are placed in the second housing 4. However, it is also possible for at least one of the sub tank 40K, the upper sub tank 53K, and the pump 52 to be placed in the second housing 4 and for the others to be placed in the first housing 3.

In the first, second and third embodiments described above, a line-type inkjet printer employing a line head is described. However, needless to say, it is also possible to apply these embodiments to a serial-type inkjet printer that performs recording while moving a recording head in the width direction of a recording medium.

In the implementation phase of the present invention, various changes can be made to the extent that the gist of the invention is not changed.

What is claimed is:

1. An inkjet printer, comprising:
a transportation unit for transporting a recording medium;
a recording unit including a recording head that jets ink to the recording medium transported by the transportation unit;
an ink path for supplying ink to the recording head;
a first housing accommodating the transportation unit and the recording unit; and
a second housing attached to the first housing and accommodating a portion of the ink path, wherein
the second housing is attached to the first housing in such a way that the second housing can be moved to a first position and to a second position that is different from the first position.

2. The inkjet printer according to claim 1, wherein:
the ink path has a sub tank placed lower than the recording head in a direction of a gravitational force; and
the sub tank is accommodated in the second housing.

3. The inkjet printer according to claim 2, wherein
the second housing rotates relative to the first housing.

4. The inkjet printer according to claim 2, wherein
the second housing slides relative to the first housing.

5. The inkjet printer according to claim 2, wherein
the second housing is attachable to and detachable from the first housing.

6. An inkjet printer, comprising:
an attachable and detachable ink cartridge;
a sub tank for temporarily pooling ink supplied from the ink cartridge;
a recording unit to which the ink is supplied from the sub tank and including a recording head that jets the ink;
a transportation unit for transporting a recording medium to the recording unit;
a first housing accommodating the transportation unit and the recording unit; and
a second housing attached to the first housing and accommodating the sub tank; wherein
the second housing is attached to the first housing in such a way that the second housing can be moved to a first position and to a second position that is different from the first position.

7. The inkjet printer according to claim 6, wherein
the second housing rotates about a rotation axis relative to the first housing.

8. The inkjet printer according to claim 6, wherein
the second housing slides relative to the first housing.

9. The inkjet printer according to claim 6, wherein
the second housing is attachable to and detachable from the first housing.

10. An inkjet printer, comprising:
a transportation unit for transporting a recording medium;
a recording unit including a recording head that jets ink to the recording medium transported by the transportation unit;
an ink circulation unit for supplying ink to the recording head, for collecting ink that was riot jetted from the recording head, and for circulating the ink in the recording head;
a first housing accommodating the transportation unit and the recording unit; and
a second housing attached to the first housing and accommodating a portion of the ink circulation unit, wherein
the second housing is attached to the first housing in such a way that the second housing can be moved to a first position and to a second position that is different from the first position.

11. The inkjet printer according to claim 10, wherein
the second housing rotates relative to the first housing.

12. The inkjet printer according to claim 10, wherein
the second housing slides relative to the first housing.

13. The inkjet printer according to claim 10, wherein
the second housing is attachable to and detachable from the first housing.

14. The inkjet printer according to claim 10, wherein:
the ink circulation unit includes a sub tank placed lower than the recording head in a direction of a gravitational force, and a pump for supplying ink from the sub tank to the recording head; and
the second housing accommodates the sub tank and the pump.

15. The inkjet printer according to claim 14, wherein
the second housing rotates relative to the first housing.

16. The inkjet printer according to claim 14, wherein
the second housing slides relative to the first housing.

17. The inkjet printer according to claim 14, wherein
the second housing is attachable to and detachable from the first housing.

18. The inkjet printer according to claim 10, wherein:
the ink circulation unit includes a first tank placed higher than the recording head in a direction of a gravitational force which supply ink to the recording head, a second tank placed lower than the recording head in the direction of the gravitational force which collect ink that was not jetted from the recording head, and a pump for supplying ink from the second tank to the first tank; and
the second housing accommodates the first tank, the second tank, and the pump.

19. The inkjet printer according to claim 18, wherein
the second housing rotates relative to the first housing.

20. The inkjet printer according to claim 18, wherein
the second housing is attachable to and detachable from the first housing.
